(19) United States
(12) Patent Application Publication
(10) Pub. No.: US 2006/0191139 A1
(43) Pub. Date: Aug. 31, 2006

(54) Developing roller and manufacturing method thereof

(75) Inventors: Masaki Hayashi, Osaka (JP); Satoshi Uemura, Osaka (JP)

Correspondence Address: SMITH, GAMBRELL & RUSSELL, LLP, 1850 M STREET, N.W., SUITE 800, WASHINGTON, DC, 20036, US

(73) Assignee: KYOCERA MITA CORPORATION

(21) Appl. No.: 11/359,419

(22) Filed: Feb. 23, 2006

(30) Foreign Application Priority Data
Feb. 25, 2005 (JP) 2005-050274

(51) Int. Cl. B21D 53/00; G03G 15/10

(52) U.S. Cl. 29/895.32; 29/895.3; 399/239

(57) ABSTRACT

A developing roller 20 included in a developing device 1 and a photoconductor drum 100 are located adjacently to or in contact with each other. A toner absorbed on the surface of the developing roller 20 moves to the photoconductor drum 100 by an electrostatic force, whereby an electrostatic latent image is formed. The developing roller 20 has on the surface thereof a developing sleeve 30. On the surface of a base 31 of the developing sleeve 30, an electroless nickel plating layer 32 is formed. Further, on the surface of the nickel plating layer 32, a nickel oxide coating 33 is formed. The nickel oxide coating 33 passivates the surface of the developing sleeve 30 to thereby suppress the tendency of the toner charge to dissipate as a result of nickel plating treatment, thus permitting the toner charge holding property to be maintained in a favorable state.

This application is based on Japanese Patent Application No. 2005-050274 filed on Feb. 25, 2005, the contents of which are hereby incorporated by reference.

### BACKGROUND OF THE INVENTION

1. Field of the Invention

The present invention relates to a developing roller applicable to a developing device for use in an electrophotographic image forming apparatus represented by a copier and a printer, and also to a manufacturing method of this developing roller.

2. Description of the Prior Art

In an electrophotographic image forming apparatus represented by a copier and a printer, after the surface of an image carrier is uniformly charged, an electrostatic latent image of the original image is formed through partial light attenuation of a potential by way of light irradiation, and a visible toner image formed by developing the electrostatic latent image with a toner is transferred onto paper. After the transfer of the toner image onto the paper, the remaining toner on the surface of the image carrier is cleaned, whereby electricity is removed therefrom in preparation for formation of a new electrostatic latent image.

In a developing device as a main part of the image formation process as described above, as a typical method of developing an electrostatic latent image, a method is adopted in which a toner is made adhere to the surface of a developing sleeve included in a developing roller, and then the toner is moved from this surface of the developing sleeve to the surface of an image carrier by an electrostatic force. One example of a developing device including such a developing roller can be observed in patent publication 1.

The developing device is required to develop an electrostatic latent image formed on the surface of the image carrier without causing any toner excess and deficiency and toner ununiformity. Thus, it is required to uniformly distribute the toner to the surface of the developing sleeve included in the developing roller without causing any toner excess and deficiency and toner ununiformity. However, repeated use of the developing roller causes gradual abrasion of the surface of the developing sleeve, resulting in failure to uniformly hold the toner on this surface, which leads to a risk of occurrence of image failure. As a countermeasure against such a problem, nickel plating treatment is performed on the surface of the developing sleeve included in the developing device described in patent publication 1 in order to improve the abrasion resistance of the surface of the developing sleeve. Similarly, patent publication 2 and patent publication 3 respectively show one example of alumite treatment and one example of chrome plating treatment both performed on the surface of the developing sleeve in order to improve the abrasion resistance of this surface.

However, the nickel plating treatment performed on the surface of the developing sleeve included in the developing roller of the developing device described in patent publication 1 provides high abrasion resistance, but raises a concern that the toner charge easily dissipates. This makes it difficult to hold the toner on the surface of the developing sleeve, which inevitably results in a decrease in the amount of toner moving to the surface of the image carrier, thus leading to a possibility of failure to provide a satisfactory image concentration.

The alumite treatment performed on the surface of the developing sleeve as performed on a cylindrical developer carrier (the developing sleeve) described in patent publication 2 typically improves the abrasion resistance and solves the problem as observed in the nickel plating treatment described in patent publication 1 that the toner charge easily dissipates, but, on the contrary, suffers from a high tendency that the toner charge hardly dissipates. This makes it difficult for the toner to move from the surface of the developing sleeve toward the surface of the image carrier, thus leading to a possibility of a ghost image problem that the image pattern formed in the last development operation adversely influences the next development operation. Moreover, due to the failure of the toner to move from the surface of the developing sleeve, the toner charge amount increases, thus leading to a risk of occurrence of a phenomenon called thin layer disturbance that the toner becomes massed together on the surface of the developing sleeve.

The chrome plating performed on the surface of the developing sleeve included in the developing roller of the developing device described in patent publication 3 provides favorable performance in terms of the abrasion resistance and the toner charge holding property, but raises a concern about the influence of the chrome on the environment. Chrome (hexavalent chromium), which is frequently used in conventional metal plating, is specified as an environmentally harmful substance in the EU countries, and thus its usage has been increasingly controlled. Accordingly, many firms in the current plating industry have been promoting disuse of chrome.

[Patent publication 1] JP-A-S58-132768

[Patent publication 2] JP-A-2003-35992

[Patent publication 3] JP-A-2001-235940

### SUMMARY OF THE INVENTION

In view of the problem described above, the present invention has been made, and it is an object of the invention to provide a developing roller for developing an electrostatic latent image formed on the surface of an image carrier, which developing roller is capable of preventing image failure such as a ghost image and thin layer disturbance and also providing a favorable image concentration by using therein a developing sleeve having improved toner charge holding property and improved abrasion resistance while giving consideration to environmental problems. It is also an object of the invention to provide a manufacturing method of such a developing roller.

To achieve the object described above, in a developing roller according to one aspect of the present invention, a nickel plating layer is formed on the surface of a base of a developing sleeve and a nickel oxide coating is formed on the surface of the nickel plating layer.

According to this configuration, the surface of the developing sleeve can be passivated. The passivation with the nickel oxide coating can suppress the tendency of the surface of the developing sleeve to dissipate the toner charge as a result of nickel plating treatment. As a result, together with the abrasion resistance possessed by the nickel plating layer, by the action of the nickel oxide coating, the toner charge holding property can be kept in a favorable state. Thus, the developing roller can be provided which is capable of preventing image failure such as a ghost image and the thin layer disturbance and also providing a favorable image concentration without using any substance harmful for the environment.

In the developing roller with the configuration described above, the base of the developing sleeve is formed of an aluminum-based metallic material.

According to this configuration, machining is easily performed. The surface of the developing sleeve requires some roughness in order to facilitate the toner holding. Forming the base of the developing sleeve with an aluminum-based metallic material permits easily and accurately forming this surface with roughness. Thus, the toner on the surface of the developing sleeve becomes stable, thus resulting in an improvement in the development performance achieved by the developing roller.

In a manufacturing method of a developing roller according to another aspect of the invention, in manufacturing a developing roller in which a nickel plating layer is formed on the surface of a base of a developing sleeve, a nickel oxide coating is formed on the surface of the nickel plating layer of the developing sleeve.

According to this configuration, the developing roller can be manufactured which has the abrasion resistance provided by the nickel plating layer and favorable toner charge holding property provided by the nickel oxide coating without causing any image failures.

In the manufacturing method of a developing roller with the configuration described above, the formation of the nickel oxide coating is achieved by repeating oxidization treatment a plurality of times.

According to this configuration, the thickness of the nickel oxide coating can arbitrarily be adjusted by selecting the number of times of oxidization treatment. This therefore permits forming the nickel oxide coating having a thickness required for maintaining a favorable toner charge holding property and thus permits manufacturing the developing roller capable of continuously forming images without causing any failures.

In the manufacturing method of a developing roller with the configuration described above, the formation of the nickel oxide coating is achieved by performing the oxidization treatment with a weak acid and then performing the oxidization treatment with a strong acid.

According to this configuration, the nickel oxide coating of a favorable thickness can be formed with a strong acid but without directly using this strong acid which possibly damage the surface of the nickel plating layer. This therefore requires less labor and time than the oxidization treatment repeatedly performed with a weak acid, thus resulting in higher operation efficiency.

In the manufacturing method of a developing roller with the configuration described above, the formation of the nickel oxide coating is achieved by immersing in an acidic aqueous solution the developing sleeve having the nickel plating layer formed on the surface of the base thereof.

According to this configuration, compared to high-temperature oxidization treatment method using a heating furnace, deterioration in the dimensional accuracy due to thermal expansion can be prevented. This therefore permits manufacturing the developing roller having a high dimensional accuracy and capable of holding a toner on the surface of the developing sleeve in a favorable state.

### DESCRIPTION OF THE DRAWINGS

FIG. 1 is a partial vertical sectional elevation of a developing device including a developing roller according to an embodiment of the present invention;

FIG. 2 is a schematic perspective view of the developing roller of FIG. 1;

FIG. 3 is an enlarged partial vertical sectional view of a developing sleeve of FIG. 1;

FIG. 4 is a table showing evaluations made on characteristics such as the image concentration, the machining performance, and the like with respect to materials of a base of the developing sleeve and surface treatment methods thereof;

FIG. 5 is a graph showing the effect that the number of times of oxidation treatment performed in formation of a nickel oxide coating on the surface of the developing sleeve has on durability in maintaining the image concentration; and

FIG. 6 is a graph showing the effect that the type of an acid used in the formation of a nickel oxide coating on the surface of the developing sleeve has on the number of times of oxidation treatment performed until the coating of a predetermined thickness is formed.

### DESCRIPTION OF THE PREFERRED EMBODIMENTS

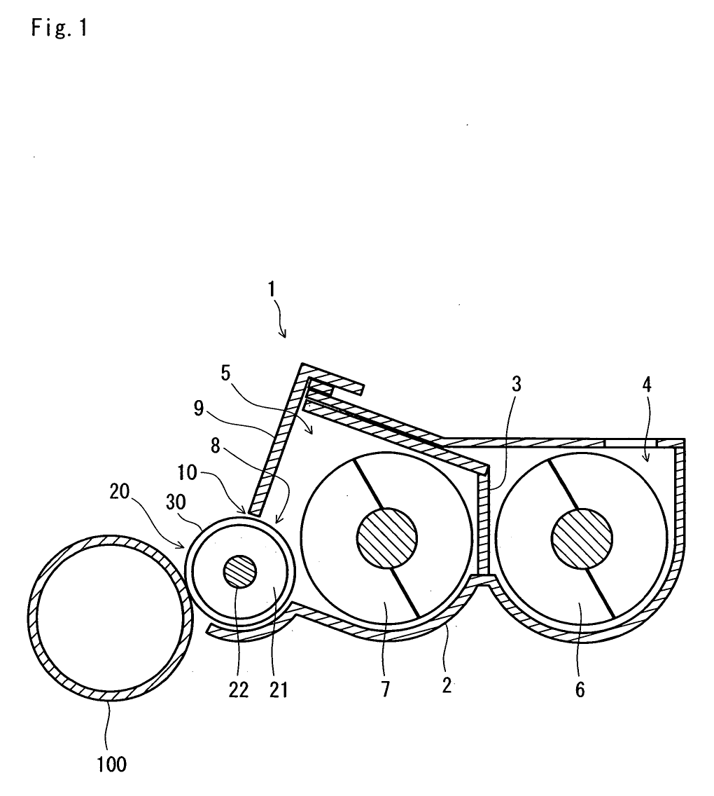

Hereinafter, a description will be given on the embodiments of the present invention, with reference to FIG. 1 to FIG. 6.

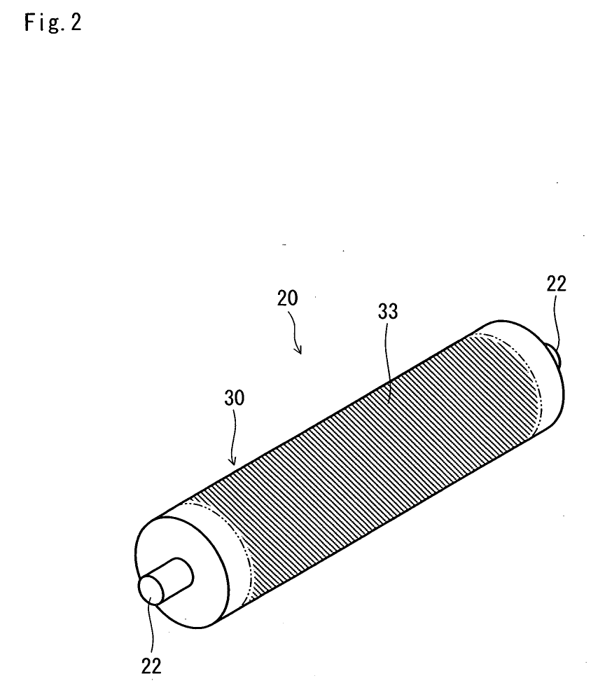

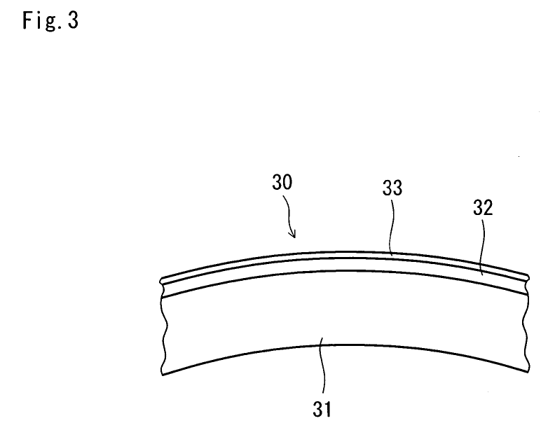

First, the structure of a developing roller according to the first embodiment of the present invention will be described, with reference to FIG. 1 to FIG. 3. FIG. 1 is a partial vertical sectional elevation of a developing device including the developing roller. FIG. 2 is a schematic perspective view of the developing roller. FIG. 3 is an enlarged partial vertical sectional view of a developing sleeve.

As shown in FIG. 1, a developing device 1 of an image forming apparatus has a developer container 2. The developer container 2 is so formed as to be elongated in the paper width direction orthogonal to the paper conveyance direction in the image forming apparatus, that is, in the depth direction as viewed on the paper surface of FIG. 1, with its longitudinal direction oriented horizontally. The inside of the developer container 2 is partitioned, by a partition wall 3 extending in the longitudinal direction of the developing container 2, into two left and right blocks as viewed in FIG. 1. The right block corresponds to a toner storage chamber 4, and the left block corresponds to a development chamber 5.

The developer container 2 stores as a developer a one-component magnetic developer of a magnetic toner. The toner as a developer is supplied from the toner storage chamber 4 to the development chamber 5. To achieve this, an opening, not shown, is provided in the both ends of the partition wall 3, where the toner storage chamber 4 and the development chamber 5 communicate with each other. A stirring screw 6 for stirring a toner is provided in the toner storage chamber 4 and a conveyance screw 7 for conveying a toner is provided in the development chamber 5, both with the axes thereof oriented horizontally.

The development chamber 5 includes an opening 8 located adjacently to a photoconductor drum 100. In the opening 8, the developing roller 20 as a developer carrier is arranged. One side of the developing roller 20 is exposed to the inside of the development chamber 5 while the other side thereof is exposed to the outside of the development chamber 5 and thus faces the photoconductor drum 100 as an image carrier. The developing roller 20 and the photoconductor drum 100 are located closer to each other or in contact with each other. The developing roller 20 is rotated counterclockwise by drive means, not shown. In the downstream side in the rotation direction from the section of the developing roller 20 exposed to the inside of the development chamber 5, that is, above the developing roller 20 in FIG. 1, a regulating plate 9 is provided, which is arranged with a gap 10 of a predetermined width provided between the lower end thereof and the surface of the developing roller 20.

As shown in FIGS. 1 and 2, the developing roller 20 includes: the developing sleeve 30, corresponding to the surface thereof, where a toner is absorbed, and a magnet 21 and a shaft part 22 arranged inside the developing sleeve 30. The developing sleeve 30 has, as shown in FIG. 3, a base 31 formed of an aluminum-based metallic material. The surface of the base 31 of the developing sleeve 30 is subjected to blasting or the like so as to be provided with an appropriate degree of roughness for the purpose of facilitating toner holding. On the surface of such a base 31, an electroless nickel plating layer 32 of a thickness of 2 to 10 μm is formed. Further, on the surface of the nickel plating layer 32, a nickel oxide coating 33 is formed.

As a manufacturing method of such a the developing roller 20, the formation of the nickel oxide coating 33 of the developing sleeve 30 is achieved by once performing immersion in an acid aqueous solution, i.e., a 20% nitric acid aqueous solution, for dozens of seconds.

In the developing device 1 structured as described above, a toner absorbed from the development chamber 5 to the surface of the developing roller 20 by the action of magnetic field reaches the gap 10 located at the lower end of the regulating plate 9 in conjunction with the rotation of the developing roller 20. At this area, under the control by the gap 10, the toner is formed into a thin layer of a predetermined width on the surface of the developing roller 20. Then, at the area where the developing roller 20 and the photoconductor drum 100 oppose each other, the toner moves to the photoconductor drum 100 whereby an electrostatic latent image is formed. The amount of toner consumed is refilled in the toner storage chamber 4 from a toner supply container, not shown.

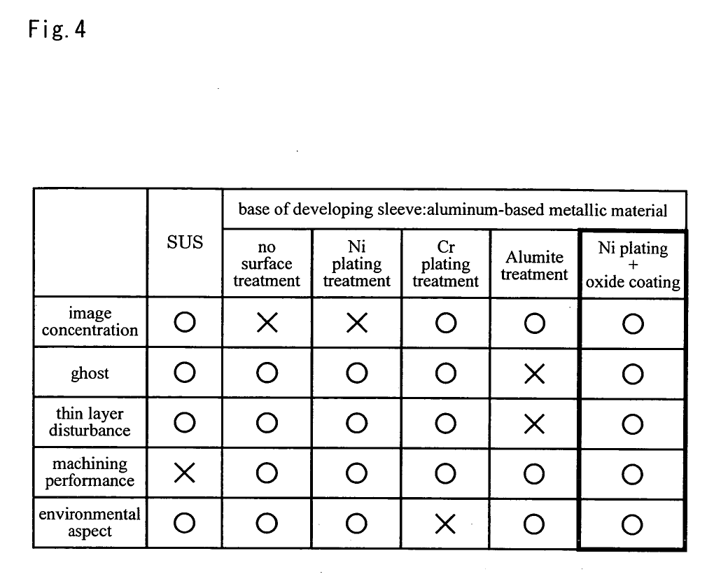

Next, a description will be given on evaluations made on characteristics such as the image concentration, the machining performance, and the like with respect to materials of the base 31 of the developing sleeve 30 included in the developing roller 20 and surface treatment methods thereof, with reference to FIG. 4. FIG. 4 is a table showing the evaluations made on the characteristics such as the image concentration, the machining performance, and the like with respect to the materials of the base 31 of the developing sleeve 30 and the surface treatment methods thereof.

As shown in FIG. 4, the materials of the base 31 of the developing sleeve 30 include SUS (stainless steel) and an aluminum-based metallic material. For the aluminum-based metallic material, evaluation is made with five types of surface treatment: no surface treatment, Ni (nickel) plating treatment, Cr (chrome) plating treatment, alumite treatment, and Ni plating treatment combined with oxide coating treatment. The characteristics to be evaluated include 5 items: the image concentration, ghost (image), thin layer disturbance, machining performance, and environmental aspect.

First, a description will be given on the evaluations made on the characteristics concerned with image formation for the base 31 of the developing sleeve 30 as described above. For the image concentration, the concentration of an image printed on paper is measured with a reflection densitometer RD-918 manufactured by GretagMacbeth Corporation, and it is judged acceptable for measured values of 1.2 or above and judged not acceptable for measured values of 1.2 or below. According to FIG. 4, when the material of the base 31 is SUS or when the material of the base 31 is an aluminum-based metallic material under the chrome plating treatment, the alumite treatment, or the nickel plating treatment with the oxide coating treatment, the results were good. On the other hand, when the material of the base 31 is an aluminum-based metallic material, the results were poor for those subjected to no surface treatment or the nickel plating treatment. It proves that the toner charge on these developing sleeves 31 easily dissipates.

For the ghost and the thin layer disturbance, the results were poor for the one whose base 31 is formed of an aluminum-based metallic material and subjected to the alumite treatment. This proves that the alumite treatment makes it difficult for the toner charge to dissipate.

For the machining performance, the result is more favorable with an aluminum-based metallic material than SUS. For the environmental aspect, as described above, it was judged that the chrome plating should be disused in view of the effect of chrome imposed on the environment.

Thus, it is judged comprehensively that favorable evaluation results are provided with the developing roller 20 of the present invention whose base 31 of the developing sleeve 30 is formed of an aluminum-based metallic material, on the surface of which base 31 a nickel plating layer is formed, on the surface of which nickel plating layer a nickel oxide coating is further formed.

As described above, in the developing roller 20, on the surface of the base 31 of the developing sleeve 30, the nickel plating layer 32 is formed, and then, on the surface of the plating layer 32, the nickel oxide coating 33 is formed. This permits passivation of the surface of the developing sleeve 30. The passivation with the nickel oxide coating 33 can suppress the tendency of the surface of the developing sleeve 30 to dissipate the toner charge as a result of the nickel plating treatment. As a result, together with the abrasion resistance possessed by the nickel plating layer 32, by the action of the nickel oxide coating 33, the toner charge holding property can be kept in a favorable state. Thus, the developing roller 20 can be provided which is capable of preventing image failure such as a ghost image and the thin layer disturbance and also providing a favorable image concentration without using any substance harmful for the environment.

In the developing roller 20 structured as described above, the base 31 of the developing sleeve 30 is formed of an aluminum-based metallic material, and thus can be easily machined. The surface of the developing sleeve 30 requires some roughness in order to facilitate the toner holding. Forming the base 31 of the developing sleeve 30 with an aluminum-based metallic material permits easily and accurately forming this surface with roughness. Thus, the toner on the surface of the developing sleeve 30 becomes stable, thus resulting in an improvement in the development performance achieved by the developing roller 20.

Then, in manufacturing the developing roller 20 including the developing sleeve 30 with the base 31 on the surface of which the nickel plating layer 32 is formed, the nickel oxide coating 33 is formed on the surface of the nickel plating layer 32 of the developing sleeve 30. Thus, this permits manufacturing the developing roller 20 having the abrasion resistance provided by the nickel plating layer 32 and favorable toner charge holding property provided by the nickel oxide coating 33 without causing any image failure.

Moreover, in the manufacturing method of the developing roller 20 structured as described above, the formation of the nickel oxide coating 33 is achieved by immersing in an acid aqueous solution the developing sleeve 30 having the nickel plating layer 32 on the surface of the base 31. Therefore, compared to high-temperature oxidization treatment method using a heating furnace, deterioration in the dimensional accuracy due to thermal expansion can be prevented. This therefore permits manufacturing the developing roller 20 having a high dimensional accuracy and capable of holding a toner on the surface of the developing sleeve 30 in a favorable state.

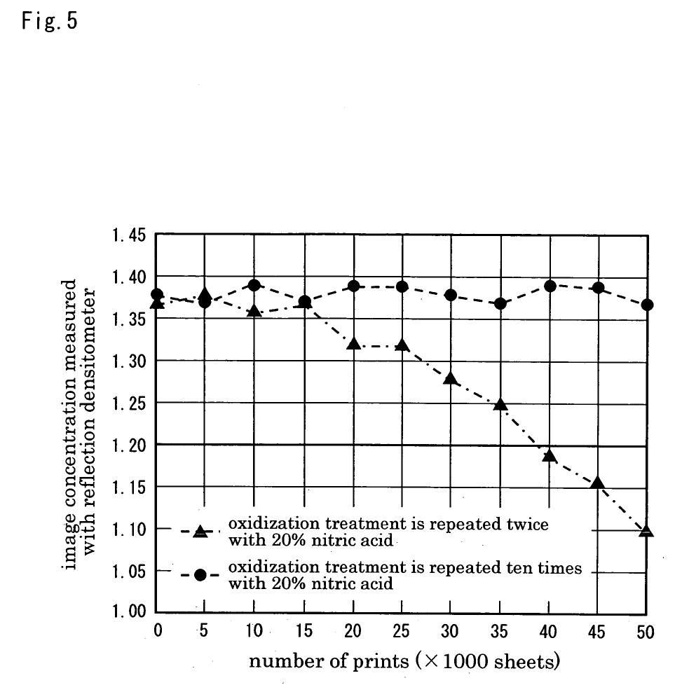

Next, a description will be given on a developing roller according to a second embodiment of the present invention, with reference to FIG. 5. FIG. 5 is a graph showing the effect that the number of times of oxidation treatment performed in formation of the nickel oxide coating on the surface of the developing sleeve has on durability in maintaining the image concentration. The basic structure of this embodiment is the same as that of the first embodiment, and thus the description and indication in the drawings of the structure thereof will be omitted.

The developing roller 20 according to the second embodiment is different from that of the first embodiment in a formation method of the nickel oxide coating 33 formed on the surface of the base 31 of the developing sleeve 30. In the second embodiment, the formation of the nickel oxide coating 33 is achieved by repeating ten times the oxidization treatment, that is, immersion in a 20% nitric acid aqueous solution as a weak acid for dozens of seconds.

As shown in FIG. 5, the durability in maintaining the image concentration was evaluated with different numbers of times of oxidization treatment performed to form the nickel oxide coating 33. The horizontal axis of FIG. 5 indicates the number of prints made on paper, reaching 50,000 at a maximum. The vertical axis of FIG. 5 indicates values of the image concentration measured with the reflection densitometer RD-918 described above, with increasingly higher concentrations upward. The broken line (with circles) refers to this embodiment and the dashed line (with triangles), which is provided as an example to be compared with this embodiment, refers to a case where the oxidization treatment is repeated twice.

According to FIG. 5, when the number of times of oxidization treatment performed to form the nickel oxide coating 33 is ten, almost no change is observed in the image concentration even after 50,000 prints were made, maintaining a favorable concentration. However, when the number of times of oxidization treatment is two, the image concentration starts to deteriorate around after 15,000 prints were made and then reaches under 1.2, the reference value in the first embodiment, after 40,000 prints were made.

In this manner, in the manufacturing method of the developing roller 20 structured as described above, the formation of the nickel oxide coating 33 on the developing sleeve 30 is achieved by repeating the oxidization treatment a plurality of times. Therefore, the thickness of the nickel oxide coating 33 can arbitrarily be adjusted by selecting the number of times of oxidization treatment. This therefore permits forming the nickel oxide coating 33 having a thickness required for maintaining a favorable toner charge holding property and thus permits manufacturing the developing roller 20 capable of continuously forming images without causing any failures.

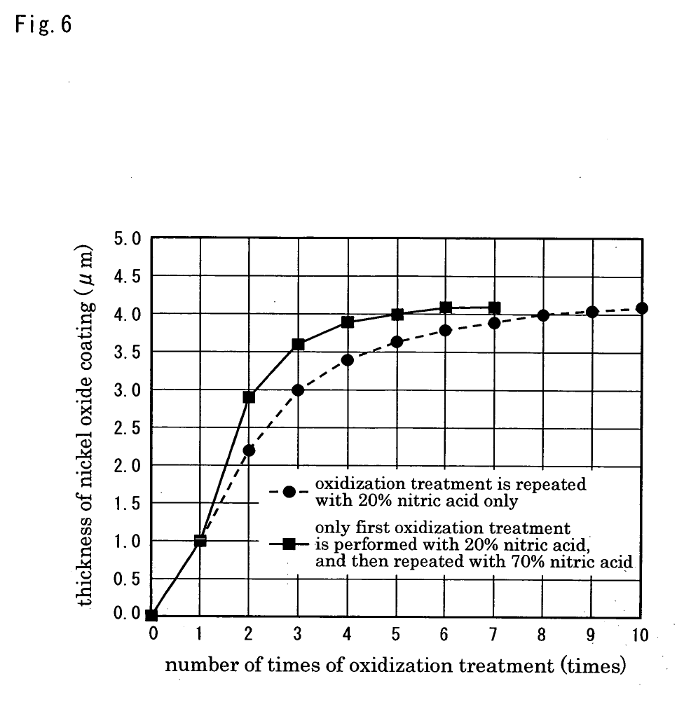

Next, a description will be given on a developing roller according to a third embodiment of the present invention, with reference to FIG. 6. FIG. 6 is a graph showing the effect that the type of an acid used in formation of the nickel oxide coating on the surface of the developing sleeve has on the number of times of oxidation treatment performed until the coating of a predetermined thickness is formed. The basic structure of this embodiment is the same as that of the first embodiment, and thus the description and indication in the drawings of the structure thereof will be omitted.

The developing roller 20 according to the third embodiment is different from those of the first and second embodiments in a formation method of the nickel oxide coating 33 formed on the surface of the base 31 of the developing sleeve 30. In the third embodiment, the formation of the nickel oxide coating 33 is achieved by performing the oxidization treatment with a 20% nitric acid aqueous solution as a weak acid and then performing the oxidization treatment with a 70% nitric acid aqueous solution as a strong acid. Note that each oxidization treatment is achieved by immersing the developing sleeve 30 in the nitric acid aqueous solution for dozens of seconds.

As shown in FIG. 6, the number of times of oxidization treatment performed until the coating of a predetermined thickness is formed was evaluated with different types of an acid used in the formation of the nickel oxide coating 33. The horizontal axis of FIG. 6 indicates the number of times of oxidization treatment performed in the formation of the nickel oxide coating 33. The vertical axis of FIG. 6 indicates the thickness of the nickel oxide coating 33. In the evaluation of this embodiment shown in FIG. 6, assuming that the reference thickness of the nickel oxide coating 33 is 4.0 μm, the number of times of oxidization treatment performed until the coating of this thickness is formed. In this embodiment, only the first oxidization treatment was performed with the 20% nitric acid aqueous solution as a weak acid, and then the second and subsequent oxidization treatment were repeated with the 70% nitric acid aqueous solution as a strong acid, the results of which are shown with a solid line (with squares). The broken line (with circles), which is provided as an example to be compared with this embodiment, indicates a case where the oxidization treatment is repeated with the 20% nitric acid aqueous solution only.

According to FIG. 6, the type of an acid used in the formation of the nickel oxide coating 33 is first a weak acid and then a strong acid, the reference coating thickness 4.0 μm is reached at the fifth oxidization treatment. However, when the oxidization treatment is repeated with a weak acid only, the reference thickness can be reached first time at the eighth oxidization treatment.

In this manner, in the manufacturing method of the developing roller 20 structured as described above, the formation of the nickel oxide coating 33 is achieved by first performing the oxidization treatment with the 20% nitric acid aqueous solution as a weak acid and then performing the oxidization treatment with the 70% nitric acid aqueous solution as a strong acid. Therefore, the nickel oxide coating 33 of a favorable thickness can be formed with a strong acid but without directly using this strong acid which possibly damage the surface of the nickel plating layer 32. This therefore requires less labor and time than the oxidization treatment repeatedly performed with a weak acid, thus resulting in higher operation efficiency.

The embodiments of the present invention have been described above, but the scope of the present invention is not limited to these embodiments. Thus, the present invention can be embodied with various modifications without departing from the sprit of the invention.

For example, in the embodiments of the present invention, a nitric acid aqueous solution is used for the formation of the nickel oxide coating 33, but an acid aqueous solution is not limited to this, and thus may be a different acid aqueous solution such as a solution of sulfuric acid, oxalic acid, or the like. A 20% nitric acid aqueous solution is used as a weak acid while a 70% nitric acid aqueous solution is used as a strong acid. However, the ratio (in percentages) between the weak acid and the strong acid is not limited to this and thus a different ratio may be employed. Further, the number of times of oxidization treatment performed in the formation the nickel oxide coating 33 is not limited to those described in the embodiments, and thus the different number of times of oxidization treatment may be performed.

The present invention is applicable to all types of developing rollers including a developing sleeve.

What is claimed is:

1. A developing roller,
wherein a nickel plating layer is formed on a surface of a base of a developing sleeve, and
wherein a nickel oxide coating is formed on a surface of the nickel plating layer.

2. The developing roller according to claim 1,
wherein the base of the developing sleeve is formed of an aluminum-based metallic material.

3. A manufacturing method of a developing roller,
wherein, in manufacturing a developing roller in which a nickel plating layer is formed on a surface of a base of a developing sleeve, a nickel oxide coating is formed on a surface of the nickel plating layer of the developing sleeve.

4. The manufacturing method of a developing roller according to claim 3,
wherein the formation of the nickel oxide coating is achieved by repeating oxidization treatment a plurality of times.

5. The manufacturing method of a developing roller according to claim 4,
wherein the formation of the nickel oxide coating is achieved by performing the oxidization treatment with a weak acid and then performing the oxidization treatment with a strong acid.

6. The manufacturing method of a developing roller according to claim 3,
wherein the formation of the nickel oxide coating is achieved by immersing in an acidic aqueous solution the developing sleeve having the nickel plating layer formed on the surface of the base thereof.

7. The manufacturing method of a developing roller according to claim 4,
wherein the formation of the nickel oxide coating is achieved by immersing in an acidic aqueous solution the developing sleeve having the nickel plating layer formed on the surface of the base thereof.

8. The manufacturing method of a developing roller according to claim 5,
wherein the formation of the nickel oxide coating is achieved by immersing in an acidic aqueous solution the developing sleeve having the nickel plating layer formed on the surface of the base thereof.
